(19) United States
(12) Patent Application Publication
(10) Pub. No.: US 2024/0280374 A1
(43) Pub. Date: Aug. 22, 2024

(54) INFORMATION PROVISION METHOD AND INFORMATION MANAGEMENT SYSTEM

(71) Applicant: Panasonic Automotive Systems Co., Ltd., Kanagawa (JP)

(72) Inventors: Akihiko IGUCHI, Osaka Fu (JP); Fumio KOSUGE, Kanagawa Ken (JP); Shinya AIZAWA, Kanagawa Ken (JP)

(73) Assignee: Panasonic Automotive Systems Co., Ltd., Kanagawa (JP)

(21) Appl. No.: 18/650,268

(22) Filed: Apr. 30, 2024

Related U.S. Application Data
(63) Continuation of application No. PCT/JP2022/032680, filed on Aug. 30, 2022.

(30) Foreign Application Priority Data
Dec. 15, 2021 (JP) 2021-203694

(51) Int. Cl. G01C 21/36; G06V 20/52

(52) U.S. Cl. CPC G01C 21/3697; G01C 21/3617; G06V 20/52; G06V 2201/08

(57) ABSTRACT

An information provision method is implemented by an information management system performing communication with a parking lot management system. According to the information provision method, a point ID and parking time information are acquired from the parking lot management system. The point ID corresponds to a user riding on a vehicle parked in the parking lot. The parking time information indicates parking time at which the user parks the vehicle in a predetermined position in the parking lot. When the parking time is included in a meal time period, recommendation information is transmitted to the parking lot management system to cause an information terminal of the user who corresponds to the point ID to display the recommendation information. The recommendation information represents one or more stores each of whose frequency of use by the user is equal to or higher than a given level, and at least one restaurant.

### CROSS-REFERENCE TO RELATED APPLICATIONS

This application is a continuation of International Application No. PCT/JP2022/032680, filed on Aug. 30, 2022 which claims the benefit of priority of the prior Japanese Patent Application No. 2021-203694, filed on Dec. 15, 2021, the entire contents of which are incorporated herein by reference.

### FIELD

The present disclosure relates generally to an information provision method and an information management system.

### BACKGROUND

The patent application JP 2006-107147 A discloses a technique for a parking lot of a commercial facility or the like. According to the technique, after a vehicle is parked, store information is notified by using information such as a desired parking position, a field of interest, and a use store of a user that is registered in advance.

Convenience for a user may be improved by notifying the user about store information about a commercial facility to be used by the user after his/her vehicle is parked in a parking lot of the commercial facility.

Under such circumstances, there is room for further improving notification contents of the store information.

### SUMMARY

An information provision method according to one embodiment of the present disclosure is implemented by an information management system. The information management system performs communication with a parking lot management system including a first server relating to a parking lot. The information management system includes a second server relating to a commercial facility. The second server stores purchase information about purchase by a user in the commercial facility to correlate with a point ID of the user. The information provision method includes acquiring a point ID and parking time information from the first server. The point ID corresponds to the user riding on a vehicle parked in the parking lot. The parking time information indicates parking time at which the user parks the vehicle in a predetermined parking position in the parking lot. A vehicle number indicating the vehicle and the parking time information are determined by the parking lot management system by using a vehicle image showing the vehicle acquired by a camera installed in the parking lot. The corresponding point ID is determined by the parking lot management system on the basis of the vehicle number. The information provision method includes, when the parking time is included in a meal time period on the basis of the purchase information and the parking time information about the user who corresponds to the point ID, transmitting recommendation information to the first server to cause an information terminal of the user who corresponds to the point ID to display the recommendation information. The recommendation information includes first position information and second position information. The first position information represents at least one of stores each of whose frequency of use by the user is equal to or higher than a given level. The second position information represents at least one restaurant.

### BRIEF DESCRIPTION OF THE DRAWINGS

FIG. 1 is a diagram illustrating an example of a configuration of a parking information-linked recommendation system according to an embodiment;

FIG. 2 is a hardware block diagram illustrating an example of a hardware configuration of an infrastructure server and a store server included in the parking information-linked recommendation system according to the embodiment;

FIG. 3 is a functional block diagram illustrating an example of a functional configuration of the infrastructure server and the store server included in the parking information-linked recommendation system according to the embodiment;

FIG. 4 is a hardware block diagram illustrating an example of a hardware configuration of an operation terminal included in the parking information-linked recommendation system according to the embodiment;

FIG. 5 is a functional block diagram illustrating an example of a functional configuration of the operation terminal included in the parking information-linked recommendation system according to the embodiment;

FIG. 6 is a sequence chart illustrating an example of a procedure of user information registration processing executed by the parking information-linked recommendation system according to the embodiment;

FIG. 7 is a sequence chart illustrating an example of a procedure of recommendation information notification processing executed by the parking information-linked recommendation system according to the embodiment;

FIG. 8 is a diagram illustrating an example of a configuration of user data stored by the infrastructure server according to the embodiment;

FIG. 9 is a diagram illustrating an example of a configuration of parking data stored by the infrastructure server according to the embodiment;

FIG. 10 is a diagram illustrating an example of a configuration of map data stored by the infrastructure server according to the embodiment;

FIG. 11 is a diagram illustrating an example of a configuration of user data stored by the store server according to the embodiment;

FIG. 12 is a diagram illustrating an example of a configuration of point data stored by the store server according to the embodiment;

FIG. 13 is a diagram illustrating an example of a configuration of POS data stored by the store server according to the embodiment;

FIG. 14 is a diagram illustrating an example of a configuration of similar store data stored by the store server according to the embodiment;

FIG. 15 is a flowchart illustrating an example of a procedure of processing executed by the store server in the parking information-linked recommendation system according to the embodiment;

FIG. 16 is a flowchart illustrating an example of a procedure of processing executed by the infrastructure server in the parking information-linked recommendation system according to the embodiment;

FIG. 17 is a diagram illustrating an example of a main menu screen displayed on the operation terminal;

FIG. 18 is a diagram illustrating an example of a user registration screen displayed on the operation terminal;

FIG. 19 is a diagram illustrating an example of a screen displayed when input user data is registered in the infrastructure server;

FIG. 20 is a diagram illustrating an example of a feedback screen indicating that the user data has been registered;

FIG. 21 is a diagram illustrating an example of a notification screen for recommendation information to be displayed on the operation terminal;

FIG. 22 is a diagram illustrating an example of a detailed display screen for the recommendation information to be displayed on the operation terminal;

FIG. 23 is a diagram illustrating another example of the notification screen for the recommendation information to be displayed on the operation terminal; and

FIG. 24 is a diagram illustrating another example of the notification screen for the recommendation information displayed on the operation terminal.

### DETAILED DESCRIPTION

An embodiment of an information provision method and an information management system implemented by a parking information-linked recommendation system according to the present disclosure will be hereinafter described with reference to the drawings.

### (Schematic Configuration of Parking Information-Linked Recommendation System)

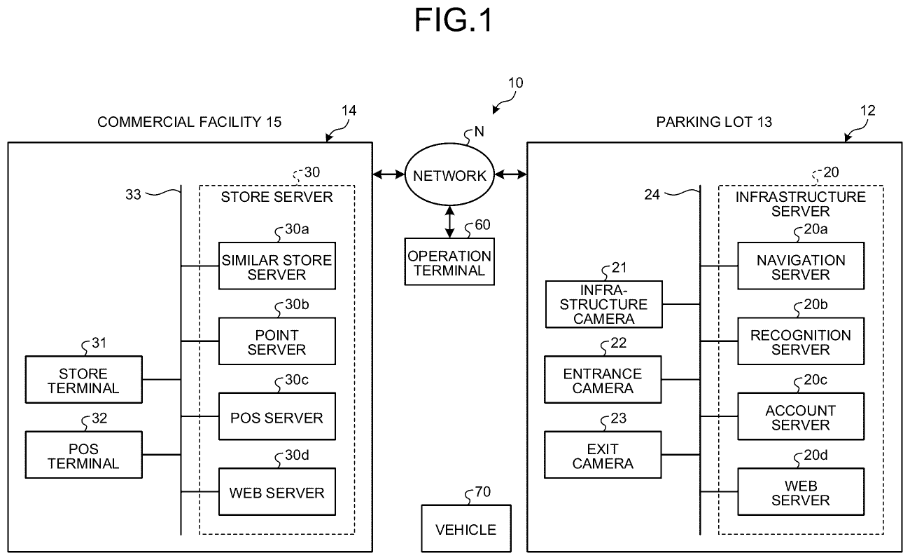

A schematic configuration of a parking information-linked recommendation system 10 will be described with reference to FIG. 1. FIG. 1 is a diagram illustrating an example of a configuration of the parking information-linked recommendation system 10 according to the embodiment.

The parking information-linked recommendation system 10 is installed in a parking lot 13 and a commercial facility 15. The parking information-linked recommendation system 10 communicates mutually with an operation terminal 60 carried by a user, the parking lot 13, and the commercial facility 15 via a network N. The parking lot 13 is adjacent to the commercial facility 15. The user parks a vehicle 70 in the parking lot 13 to go shopping in the commercial facility 15. Note that the network N is a mobile phone network including a large number of base stations as terminals, a satellite communication network that uses communication satellites, and so forth.

The parking information-linked recommendation system 10 notifies the user, who visits the parking lot 13 of the commercial facility 15, about recommendation information corresponding to parking time of the vehicle 70 on the basis of user information registered in advance by the user with the operation terminal 60 and vehicle information correlated with the user information. Here, the recommendation information is information about at least one recommended store that is selected based on the parking time from among multiple stores provided in the commercial facility 15.

Note that the vehicle correlated with the user information is, for example, a vehicle owned by the user, but is not limited thereto. For example, the user may register a vehicle on which the user rides together such as a vehicle of a family member or a friend or may register a vehicle that is temporarily or intermittently used by using a rental car, car sharing, or the like.

The parking lot 13 includes a parking lot management system 12 in which an infrastructure server 20, an infrastructure camera 21, an entrance camera 22, and an exit camera 23 are connected by a LAN 24.

The infrastructure server 20 performs various kinds of processing relating to management of the parking lot 13. The infrastructure server 20 includes a navigation server 20a, a recognition server 20b, an account server 20c, and a WEB server 20d. Note that the infrastructure server 20 is an example of a first server in the present disclosure.

The navigation server 20a acquires position information and map information relating to the parking lot 13, and searches for an entrance that is closest from a parking position of the vehicle 70 and that connects the parking lot 13 and the commercial facility 15. The navigation server 20a provides a search result to the operation terminal 60 of the user via the network N.

The recognition server 20b recognizes a parked vehicle position and fullness information/vacancy information about the parking lot 13 and updates the parked vehicle position and the fullness information/vacancy information at any time. More specifically, the recognition server 20b recognizes a number indicated on a license plate, a vehicle model, and a vehicle body color of the vehicle 70 that has entered the parking lot 13, on the basis of an image captured by the entrance camera 22. The recognition server 20b recognizes a current position and a vehicle state of the vehicle 70 by extracting characteristics of the vehicle 70 from images captured by multiple infrastructure cameras 21 and tracking the vehicle 70 on the basis of the characteristics. Examples of the characteristics of the vehicle 70 include a number indicated on the license plate, the vehicle model, and the vehicle body color of the vehicle 70. The recognition server 20b acquires a state of the parking lot 13, namely, fullness information or vacancy information on the basis of the images captured by the multiple infrastructure cameras 21.

The account server 20c manages the vehicle information and the user information by correlating with each other.

The WEB server 20d manages access to the network N and information such as display contents to be transmitted to the operation terminal 60.

Note that the infrastructure server 20 has been described as including a plurality of server devices. However, the plurality of server devices may be integrated into at least one server device. Moreover, at least one of the navigation server 20a, the recognition server 20b, the account server 20c, and the WEB server 20d may be configured by a plurality of server devices.

The infrastructure cameras 21 are installed on the ceiling or the like of the parking lot 13 so as to monitor the inside of the parking lot 13 without omission and capture images of the inside of the parking lot 13 at any time. The infrastructure cameras 21 transmit the captured images to the infrastructure server 20. The infrastructure server 20 analyzes the images captured in time series by the infrastructure cameras 21 to determine the current position of the vehicle 70 by using the number indicated on the license plate, the vehicle model, and the vehicle body color, which have been recognized from the image captured by the entrance camera 22 when the vehicle 70 entered the parking lot 13.

The entrance camera 22 is installed in an entrance gate of the parking lot 13 to capture an image including the license plate of the vehicle 70 entering the parking lot 13. The entrance camera 22 transmits the captured image to the infrastructure server 20. The infrastructure server 20 recognizes the number indicated on the license plate, the vehicle model, and the vehicle body color of the vehicle 70 by analyzing the image captured by the entrance camera 22. In addition, the infrastructure server 20 recognizes an occupant of the vehicle 70 by analyzing the image captured by the entrance camera 22.

The exit camera 23 is installed in an exit gate of the parking lot 13 to capture an image including a license plate of the vehicle 70 exiting the parking lot 13. The exit camera 23 transmits the captured image to the infrastructure server 20.

The commercial facility 15 includes a sales information management system 14 in which a store server 30, a store terminal 31, and a POS terminal 32 are connected by a LAN 33. Note that the sales information management system 14 is an example of an information management system in the present disclosure.

The store server 30 performs various kinds of processing relating to sales management in the commercial facility 15. The store server 30 includes a similar store server 30a, a point server 30b, a POS server 30c, and a WEB server 30d. Note that the store server 30 is an example of a second server in the present disclosure.

The similar store server 30a discriminates and manages similarity of stores in the commercial facility 15. In addition, the similar store server 30a selects a recommended store on the basis of one of predetermined time segments, to which a parking start time of the vehicle 70 belongs, and transmits store information indicating the selected recommended store to the infrastructure server 20. In the following description, the store information about the selected recommended store may also be referred to as recommendation information.

The point server 30b performs management of user information and point granting management. The point server 30b generates coupon information to be transmitted to the user. The coupon information is, for example, discount information about an item, which is usable in a store selected based on the parking time.

The POS server 30c manages sales data.

The WEB server 30d performs management of access to the network N and information such as display to be transmitted to the operation terminal 60.

The store server 30 has been described as being configured by a plurality of server devices. However, the plurality of server devices may be integrated into at least one server device. At least one of the similar store server 30a, the point server 30b, the POS server 30c, and the WEB server 30d may be configured by a plurality of server devices.

The operation terminal 60 is a portable terminal carried by the user and is, for example, a smartphone or a tablet terminal. The operation terminal 60 functions as an information input terminal when the user information and the vehicle information are registered. The operation terminal 60 functions as a display terminal that displays, in a manner of allowing browsing, recommendation information, map information, and the like transmitted from the infrastructure server 20. Note that the operation terminal 60 is an example of an information terminal in the present disclosure.

### (Hardware Configuration of Server Device)

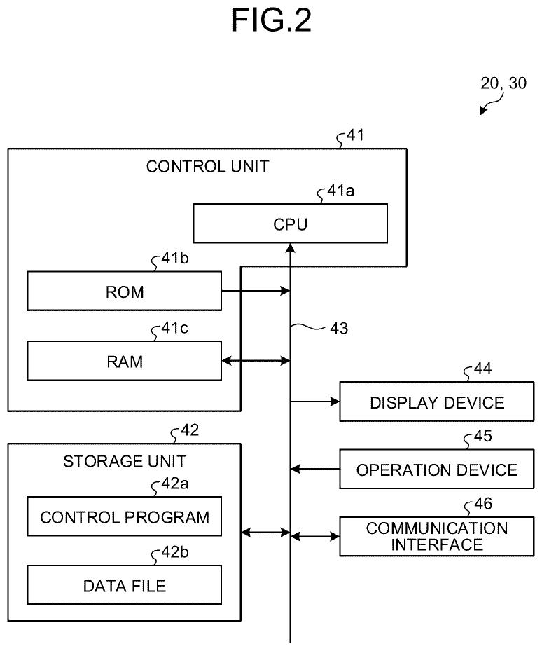

A hardware configuration of the infrastructure server 20 and the store server 30 included in the parking information-linked recommendation system 10 will be described with reference to FIG. 2. FIG. 2 is a hardware block diagram illustrating an example of the hardware configuration of the infrastructure server 20 and the store server 30 included in the parking information-linked recommendation system 10 according to the embodiment.

The infrastructure server 20 and the store server 30 have the same hardware configuration. Specifically, the infrastructure server 20 and the store server 30 have a configuration in which a control unit 41, a storage unit 42, a display device 44, an operation device 45, and a communication interface 46 are connected to one another by an internal bus 43.

Note that the navigation server 20a, the recognition server 20b, the account server 20c, and the WEB server 20d configuring the infrastructure server 20 and the similar store server 30a, the point server 30b, the POS server 30c, and the WEB server 30d configuring the store server 30 all have the hardware configuration illustrated in FIG. 2. Thus, the hardware configuration illustrated in FIG. 2 may be regarded as the respective hardware configuration of the navigation server 20a, the recognition server 20b, the account server 20c, and the WEB server 20d configuring the infrastructure server 20. The hardware configuration illustrated in FIG. 2 may be regarded as a hardware configuration of the similar store server 30a, the point server 30b, the POS server 30c, and the WEB server 30d configuring the store server 30.

The control unit 41 executes various control relating to the infrastructure server 20 and the store server 30. The control unit 41 includes a CPU (Central Processing Unit) 41a, a ROM (Read Only Memory) 41b, and a RAM (Random Access Memory) 41c. The CPU 41a is connected to the ROM 41b and the RAM 41c via the internal bus 43.

The CPU 41a loads, on the RAM 41c, various computer programs stored in the ROM 41b and the storage unit 42. The CPU 41a operates in accordance with various computer programs loaded on the RAM 41c to control operations of the infrastructure server 20 and the store server 30. The control unit 41 has a configuration of a general computer.

The storage unit 42 is a storage device such as a HDD (Hard Disk Drive) or an SSD (Solid State Drive). The storage unit 42 may be a nonvolatile memory such as a flash memory in which stored information is retained even when power is turned off. The storage unit 42 stores a control program 42a and a data file 42b.

The control program 42a is a computer program for controlling an operation of the entire infrastructure server 20 and the entire store server 30.

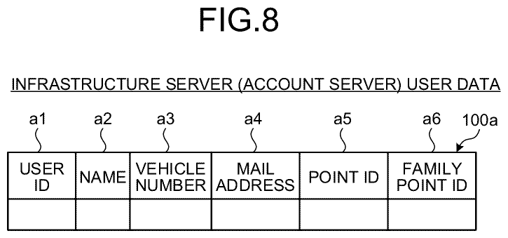

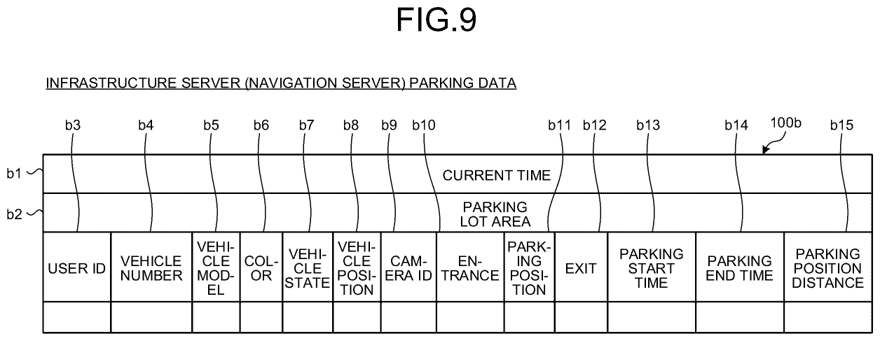

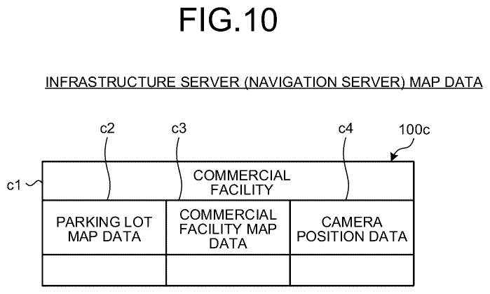

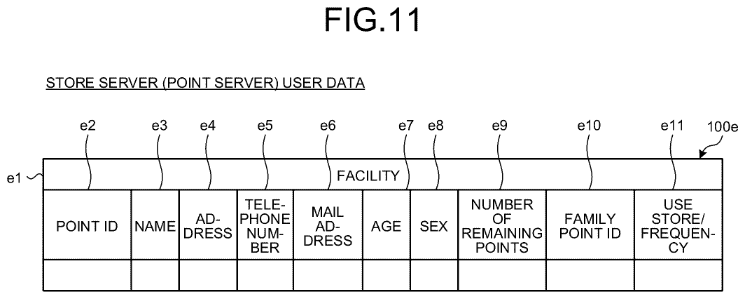

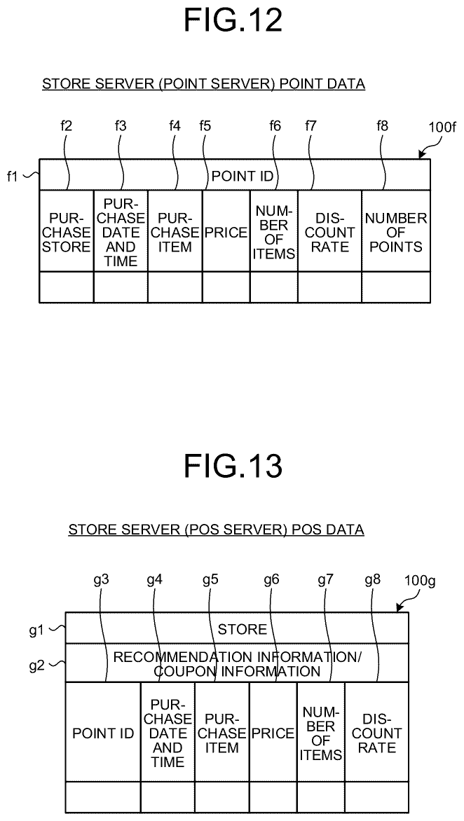

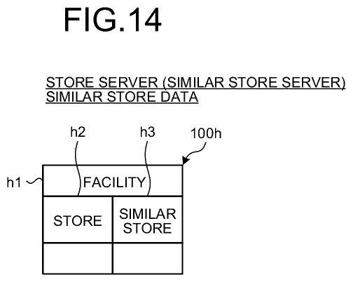

The data file 42b is a file storing various kinds of information acquired or generated by the infrastructure server 20 and the store server 30. Specifically, the infrastructure server 20 (the account server 20c) stores user data 100a (see FIG. 8) in the data file 42b. The infrastructure server 20 (the navigation server 20a) stores parking data 100b (see FIG. 9) and map data 100c (see FIG. 10) in the data file 42b. The store server 30 (the point server 30b) stores user data 100e (see FIG. 11) and point data 100f (see FIG. 12) in the data file 42b. The store server 30 (the POS server 30c) stores POS data 100g (see FIG. 13) in the data file 42b. The store server 30 (the similar store server 30a) stores similar store data 100h (see FIG. 14) in the data file 42b.

The display device 44 displays a screen generated according to an instruction of the control unit 41. The display device 44 is configured by a device such as an LCD (Liquid Crystal Display) or an organic EL (Electro-Luminescence).

The operation device 45 acquires input operation of an operator and transmits the input operation to the control unit 41. The operation device 45 is configured by a device such as a keyboard or a touch panel.

The communication interface 46 is an interface for performing communication with the infrastructure server 20 and the store server 30 via the network N. The communication interface 46 is an interface for performing communication with the infrastructure server 20 and the operation terminal 60 via the network N or a publicly known communication line such as a mobile phone network.

### (Functional Configuration of Server Device)

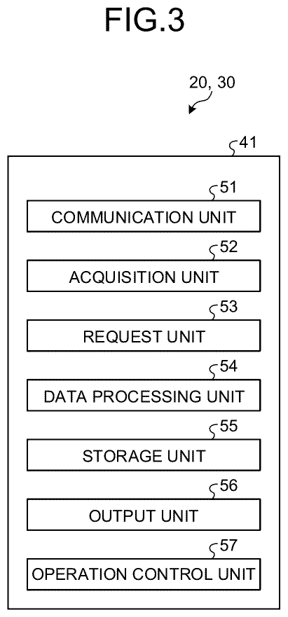

A functional configuration of the infrastructure server 20 and the store server 30 included in the parking information-linked recommendation system 10 will be described with reference to FIG. 3. FIG. 3 is a functional block diagram illustrating an example of a functional configuration of the infrastructure server and the store server included in the parking information-linked recommendation system according to the embodiment.

Note that the navigation server 20a, the recognition server 20b, the account server 20c, and the WEB server 20d configuring the infrastructure server 20 and the similar store server 30a, the point server 30b, the POS server 30c, and the WEB server 30d configuring the store server 30 all have the functional configuration illustrated in FIG. 3.

The control unit 41 of the infrastructure server 20 and the store server 30 loads and executes the control program 42a on the RAM 41c to implement, as functional units, a communication unit 51, an acquisition unit 52, a request unit 53, a data processing unit 54, a storage unit 55, an output unit 56, and an operation control unit 57 illustrated in FIG. 3.

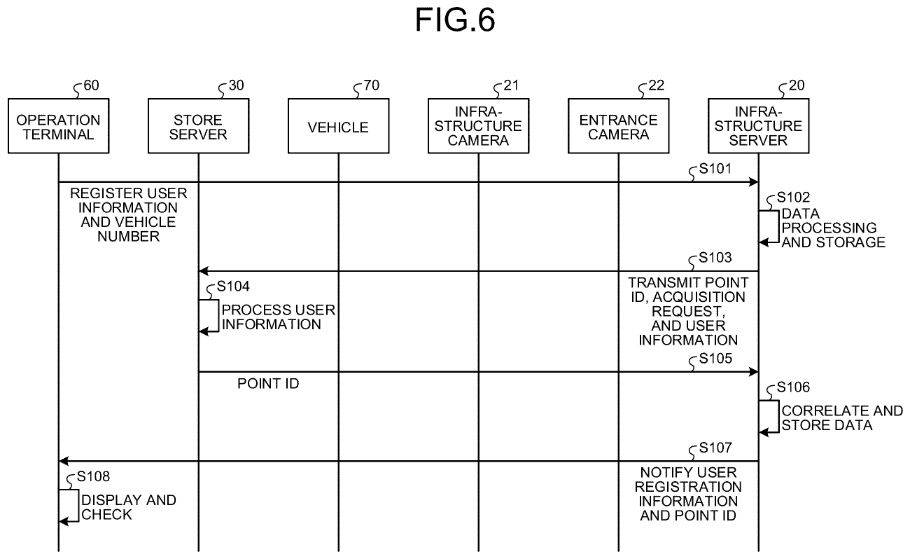

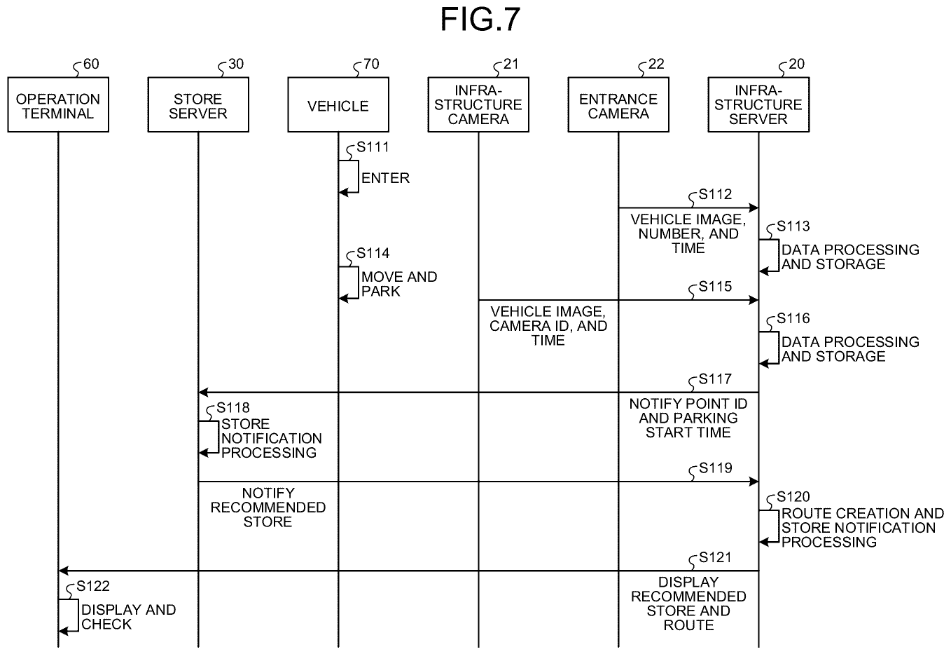

The communication unit 51 transmits and receives information between the infrastructure server 20 and the store server 30 or between the operation terminal 60 and the infrastructure server 20. The communication unit 51 transmits and receives information via the network N or a publicly known communication line such as a mobile phone network. Specific information to be transmitted and received will be described later with reference to sequence charts (see FIG. 6 and FIG. 7).

The acquisition unit 52 acquires various kinds of information received by the communication unit 51.

The request unit 53 makes a processing request to the other server between the infrastructure server 20 and the store server 30, on the basis of, for example, a processing result of the data processing unit 54.

The data processing unit 54 performs predetermined data processing on the basis of the information acquired by the acquisition unit 52.

The storage unit 55 stores the various kinds of information acquired by the acquisition unit 52, a processing result of the data processing unit 54, and the like.

The output unit 56 passes information that needs to be output to the outside to the communication unit 51 and causes the communication unit 51 to transmit the information.

The operation control unit 57 controls operation of the infrastructure server 20 and the store server 30 by executing the control program 42a.

### (Hardware Configuration of Operation Terminal)

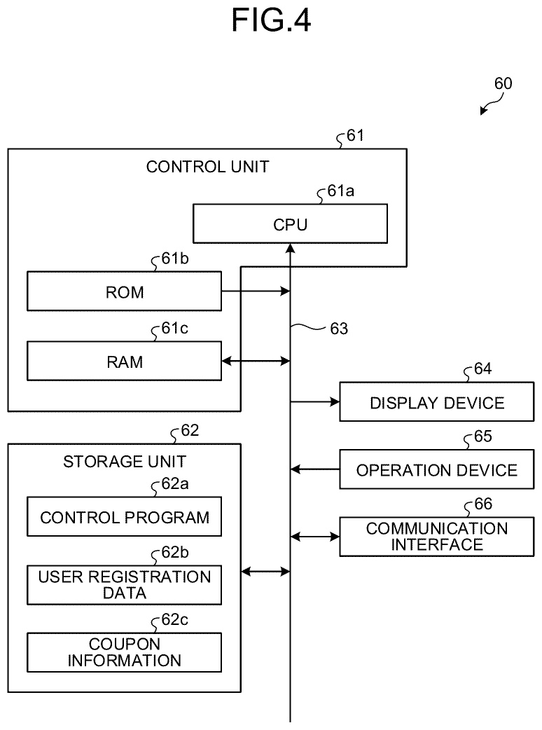

A hardware configuration of the operation terminal 60 will be described with reference to FIG. 4. FIG. 4 is a hardware block diagram illustrating an example of a hardware configuration of the operation terminal 60 included in the parking information-linked recommendation system according to the embodiment.

The operation terminal 60 has a configuration in which a control unit 61, a storage unit 62, a display device 64, an operation device 65, and a communication interface 66 are connected to one another by an internal bus 63.

The control unit 61 executes various control relating to the operation terminal 60. The control unit 61 includes a CPU 61a, a ROM 61b, and a RAM 61c. The CPU 61a is connected to the ROM 61b and the RAM 61c via the internal bus 63.

The CPU 61a loads, on the RAM 61c, various programs stored in the ROM 61b and the storage unit 62. The CPU 61a controls an operation of the operation terminal 60 by operating according to various programs loaded on the RAM 61c. The control unit 61 has a configuration of a general computer.

The storage unit 62 is a storage device such as an HDD or an SSD. The storage unit 62 may be a nonvolatile memory such as a flash memory in which stored information is retained even when the power is turned off. The storage unit 62 stores a control program 62a, user registration data 62b, and coupon information 62c.

The control program 62a is a program for controlling an operation of the entire operation terminal 60.

The user registration data 62b is a data file storing various kinds of attribute information input by the user.

The coupon information 62c is coupon information notified by the infrastructure server 20.

The display device 64 displays a screen generated according to an instruction of the control unit 61. The display device 64 is configured by a device such as an LCD or an organic EL.

The operation device 65 acquires input operation of the operator and transmits the input operation to the control unit 61. The operation device 65 is configured by a device such as a keyboard or a touch panel.

The communication interface 66 is an interface for performing communication with the infrastructure server 20 via the network N or a known communication line such as a mobile phone network.

### (Functional Configuration of Operation Terminal)

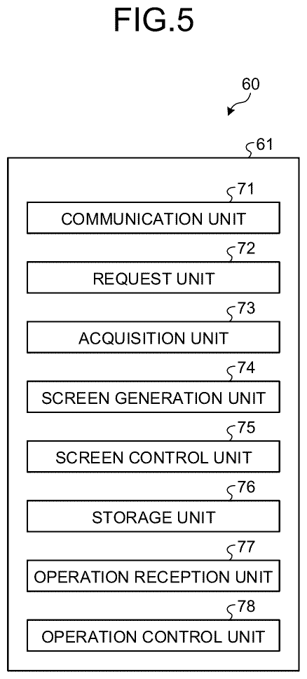

A functional configuration of the operation terminal 60 will be described with reference to FIG. 5. FIG. 5 is a functional block diagram illustrating an example of a functional configuration of the operation terminal 60 included in the parking information-linked recommendation system 10 according to the embodiment.

The control unit 61 of the operation terminal 60 loads the control program 62a on the RAM 61c and executes the control program 62a to implement, as functional units, a communication unit 71, a request unit 72, an acquisition unit 73, a screen generation unit 74, a screen control unit 75, a storage unit 76, an operation reception unit 77, and an operation control unit 78 illustrated in FIG. 5.

The communication unit 71 transmits and receives information between the operation terminal 60 and the infrastructure server 20. For example, the communication unit 71 transmits user information, vehicle information, and the like input to the operation terminal 60 to the infrastructure server 20 via the network N or a publicly known communication line such as a mobile phone network. The communication unit 71 receives user registration information, recommendation information, and the like from the infrastructure server 20.

The request unit 72 makes a processing request to the infrastructure server 20 in response to operation information acquired by the operation reception unit 77.

The acquisition unit 73 acquires information received by the communication unit 71 from the infrastructure server 20.

The screen generation unit 74 generates screen information to be displayed on the display device 64 of the operation terminal 60.

The screen control unit 75 causes the display device 64 of the operation terminal 60 to display the screen information generated by the screen generation unit 74.

The storage unit 76 stores various kinds of information acquired by the acquisition unit 73, in the storage unit 62 of the operation terminal 60.

The operation reception unit 77 receives an operation instruction and an information input from the user by acquiring input information to the operation device 65 of the operation terminal 60.

The operation control unit 78 controls operation of the operation terminal 60 by executing the control program 62a on the basis of information acquired by the operation terminal 60.

### (Procedure of User Information Registration Processing)

A procedure of user information registration processing performed by the parking information-linked recommendation system 10 will be described with reference to FIG. 6. FIG. 6 is a sequence chart illustrating an example of a procedure of user information registration processing executed by the parking information-linked recommendation system 10 according to the embodiment. Note that, in FIG. 6, description of a portion that performs data transmission and reception between different servers is omitted on the inside of the infrastructure server 20 or the inside of the store server 30.

The communication unit 71 of the operation terminal 60 transmits user information input by the user and vehicle information such as a vehicle number to the infrastructure server 20 (the account server 20c) (step S101).

The data processing unit 54 of the infrastructure server 20 (the account server 20c) converts the acquired user information and the acquired vehicle information such as the vehicle number into a predetermined format. Then, the storage unit 55 stores, in the data file 42b, the user information and the vehicle information converted into the predetermined format (step S102).

The request unit 53 of the infrastructure server 20 (the WEB server 20d) transmits the user information to the store server 30 (the WEB server 30d) to request acquisition of a point ID (step S103).

The data processing unit 54 of the store server 30 (the point server 30b) performs, on the basis of the user information acquired at step S103, user information processing for reading a point ID correlated with the user information (step S104).

The output unit 56 of the store server 30 (the WEB server 30d) causes the communication unit 51 to transmit the read point ID to the infrastructure server 20 (the WEB server 20d) (step S105).

The acquisition unit 52 of the infrastructure server 20 (the account server 20c) acquires the point ID received by the communication unit 51. Then, the storage unit 55 stores the user information and the point ID to correlate with each other (step S106).

The output unit 56 of the infrastructure server 20 (the WEB server 20d) causes the communication unit 51 to transmit registration information (the user information and the vehicle information) registered at step S102 and the point ID to the operation terminal 60 (step S107).

The acquisition unit 73 of the operation terminal 60 acquires the user information, the vehicle information, and the point ID. Then, the screen generation unit 74 of the operation terminal 60 generates screen information for causing the display device 64 of the operation terminal 60 to display the acquired kinds of information. The screen control unit 75 of the operation terminal 60 causes the display device 64 of the operation terminal 60 to display the screen information generated by the screen generation unit 74 (step S108). The user checks the user information, the vehicle information, and the point ID by browsing a screen displayed on the display device 64.

### (Procedure of Recommendation Information Notification Processing)

A procedure of recommendation information notification processing performed by the parking information-linked recommendation system 10 will be described with reference to FIG. 7. FIG. 7 is a sequence chart illustrating an example of a procedure of recommendation information notification processing executed by the parking information-linked recommendation system 10 according to the embodiment. Note that, in FIG. 7, description of a portion that transmits and receives data between different servers is omitted on the inside of the infrastructure server 20 or the inside of the store server 30.

The vehicle 70 enters the parking lot 13 (step S111).

The entrance camera 22 captures an image including the license plate of the vehicle 70 and transmits the image to the infrastructure server 20 (the WEB server 20d) together with information about time at which the image was captured (step S112).

The acquisition unit 52 of the infrastructure server 20 (the recognition server 20b) acquires the image including the license plate of the vehicle 70 and the information about time at which the image was captured transmitted at step S112. Then, the data processing unit 54 of the infrastructure server 20 (the recognition server 20b) acquires or generates data corresponding to relevant parts of parking data 100b (see FIG. 9) described later, namely, a user ID, a vehicle number, a vehicle model, a color, a vehicle state, a vehicle position, a camera ID, an entrance, and parking start time illustrated in FIG. 9 described later and stores the data as the parking data 100b (step S113).

The vehicle 70 that has entered the parking lot 13 moves in the parking lot 13, and is parked in a place where the vehicle 70 can be parked (step S114).

The infrastructure camera 21 transmits an image of the inside of the parking lot 13 captured at any time and the information about time at which the image was captured to the infrastructure server 20 (the WEB server 20d) (step S115).

The acquisition unit 52 of the infrastructure server 20 (the recognition server 20b) acquires the image of the inside of the parking lot 13 and the information about time at which the image was captured transmitted at step S115. Then, the data processing unit 54 of the infrastructure server 20 (the recognition server 20b) recognizes the vehicle 70 out of the acquired image and specifies completion of parking of the vehicle 70 and a parking position of the vehicle 70. The storage unit 55 of the infrastructure server 20 (the navigation server 20a) stores the parking position of the vehicle 70 and the parking start time of the vehicle 70 (step S116).

The output unit 56 of the infrastructure server 20 (the WEB server 20d) causes the communication unit 51 to transmit the point ID correlated with the user of the vehicle 70 and the parking time information indicating the parking start time of the vehicle 70 to the store server 30 (the WEB server 30d) (step S117). Note that the user of the vehicle 70 may be a driver of the vehicle 70 or a fellow passenger of the vehicle 70 such as a family member or a friend of the driver of the vehicle 70. The riding of the user, the family member of the user, or the friend of the user on the vehicle 70 can be recognized by, for example, detecting an occupant whose face matches a face image registered in advance out of images captured by the entrance camera 22 and the infrastructure camera 21. When the vehicle 70 is provided with an on-board device having a function to perform communication with the infrastructure server 20, the infrastructure server 20 may receive, from the on-board device of the vehicle 70, information representing presence of a user registered in the user data 100a (see FIG. 10) among occupants riding on the vehicle 70 and a user ID of this user.

The acquisition unit 52 of the store server 30 (the similar store server 30a) acquires the point ID correlated with the user of the vehicle 70 and the parking start time of the vehicle 70 transmitted at step S117. Then, the data processing unit 54 of the store server 30 (the similar store server 30a) selects a recommended store on the basis of one of predetermined time segments, to which the parking start time of the vehicle 70 belongs, and performs store notification processing for notifying recommendation information representing the selected recommended store (step S118).

The output unit 56 of the store server 30 (the WEB server 30d) causes the communication unit 51 to transmit the recommendation information representing the recommended store selected at step S118 to the infrastructure server 20 (the WEB server 20d) (step S119).

The acquisition unit 52 of the infrastructure server 20 (the account server 20c) acquires the recommendation information representing the recommended store transmitted at step S119. The data processing unit 54 of the infrastructure server 20 (the navigation server 20a) performs, on the basis of the information about the position of the recommended store included in the recommendation information, route creation/store notification processing for generating map information indicating a route from the parking position of the vehicle 70 to the recommended store via an entrance connecting the parking lot 13 and the commercial facility 15 (step S120).

The output unit 56 of the infrastructure server 20 (the WEB server 20d) causes the communication unit 51 to transmit the recommendation information and the map information to the operation terminal 60 carried by the user of the vehicle 70 (step S121).

The acquisition unit 73 of the operation terminal 60 acquires the recommendation information and the map information. The screen generation unit 74 of the operation terminal 60 generates screen information for causing the display device 64 of the operation terminal 60 to display the acquired kinds of information. The screen control unit 75 of the operation terminal 60 causes the display device 64 of the operation terminal 60 to display the screen information generated by the screen generation unit 74 (step S122). The user checks the recommendation information and the map information by browsing a screen displayed on the display device 64.

In one example, when the parking time is included in a meal time period on the basis of purchase information about the user who corresponds to the point ID and the parking time information, the data processing unit 54 of the store server 30 (the similar store server 30a) transmits recommendation information including information representing a first position of at least one of stores each of whose frequency of use by the user is equal to or higher than a given level and information representing a second position of at least one restaurant to the infrastructure server 20, in order to cause the operation terminal 60 of the user who corresponds to the point ID to display the recommendation information.

In another example, when the parking time is not included in the meal time period, the recommendation information includes information representing the first position of the at least one of stores each of whose frequency of use by the user is equal to or higher than the given level and does not include the information representing the second position of the at least one restaurant.

The meal time period is an example of one of predetermined time segments. The meal time period is, for example, a lunch time that is a period of time for a lunch. Alternatively, the meal time period includes, for example, the lunch time and a time period from a predetermined time before the lunch time to the lunch time.

When the parking time is after the lunch time in a case where the parking time is not included in the meal time period, the recommendation information includes the information representing the first position of the at least one of stores each of whose frequency of use by the user is equal to or higher than the given level and does not include the information representing the second position of the at least one restaurant.

When the parking time is after the lunch time in the case where the parking time is not included in the meal time period, the recommendation information includes the information representing the first position of the at least one of stores each of whose frequency of use by the user is equal to or higher than the given level, does not include the information representing the second position of the at least one restaurant, and includes information representing a third position of at least one coffee shop.

While the lunch time is exemplified as the meal time period, the meal time period is not limited thereto. As the meal time period, a breakfast or dinner time period can be used.

As the time segments, the meal time period and the time periods other than the meal time period are exemplified. However, the time segments are not limited thereto. As the time segments, for example, a time period starting from an opening or closing time of the commercial facility 15 can be used.

In the above description, the recommended store based on the parking time is selected from among: at least one of stores each of whose frequency of use by the user is equal to or higher than the given level, at least one restaurant, and at least one coffee shop. However, selection of the recommended store is not limited thereto. Correspondence between the time segments and the recommended store can be optionally set.

Note that, in the recommendation information displayed on the operation terminal 60, the information about the position of the recommended store may be text information such as a floor number and/or an area name.

### (Configuration of User Data)

A configuration of the user data 100a stored by the infrastructure server 20 (the account server 20c) will be described with reference to FIG. 8. FIG. 8 is a diagram illustrating an example of a configuration of the user data stored by the infrastructure server according to the embodiment.

The user data 100a includes a user ID a1, a name a2, a vehicle number a3, a mail address a4, a point ID a5, and a family point ID a6. The user ID of the user, the point ID, and the vehicle number are stored so as to correlate with one another.

The user ID a1 is identification information that is managed by the infrastructure server 20, and uniquely identifies a user who uses the parking lot 13.

The name a2 is a name of the user who corresponds to the user ID a1.

The vehicle number a3 is information described in the license plate of the vehicle 70.

The mail address a4 is a mail address of the operation terminal 60 carried by the user who corresponds to the user ID a1.

The point ID a5 is identification information that is managed by the store server 30 and uniquely identifies the user. Note that the user ID a1 and the point ID a5 indicate the same user and are only different in that the user ID a1 and the point ID a5 are managed by different servers.

The family point ID a6 is a point ID of a user correlated with the user registered in the user ID a1, for example, a family member of the user registered in the user ID a1.

Note that, although not illustrated in FIG. 8, the user data 100a may further include a password corresponding to the user of the user ID a1. The user data 100a includes a name of a vehicle model and a color of a vehicle corresponding to the registered vehicle number a3.

Although not illustrated in FIG. 8, a face image of the user or an image of the family member having the family point ID may be registered as the user data 100a. Since the face image of the user is registered as described above, the infrastructure server 20 (the recognition server 20b) can perform matching processing for matching a face of an occupant in the vehicle 70 with the face image of the user registered in the user data 100a. Consequently, it is possible to identify the occupant of the vehicle 70.

### (Configuration of Parking Data)

A configuration of the parking data 100b stored by the infrastructure server 20 (the navigation server 20a) will be described with reference to FIG. 9. FIG. 9 is a diagram illustrating an example of a configuration of the parking data stored by the infrastructure server according to the embodiment.

The parking data 100b includes current time b1, a parking lot area b2, a user ID b3, a vehicle number b4, a vehicle model b5, a color b6, a vehicle state b7, a vehicle position b8, a camera ID b9, an entrance b10, a parking position b11, an exit b12, a parking start time b13, a parking end time b14, and a parking position distance b15.

The current time b1 is current time measured by the infrastructure server 20.

The parking lot area b2 indicates a section in the parking lot 13.

The user ID b3 is identification information that is managed by the infrastructure server 20 and uniquely identifies the user who uses the parking lot 13.

The vehicle number b4 is information described in the license plate of the vehicle 70.

The vehicle model b5 is a vehicle name of the vehicle 70.

The color b6 is a color of the vehicle 70.

The vehicle state b7 indicates a state of the vehicle 70 on the inside of the parking lot 13. In the vehicle state b7, for example, “moving”, “parking”, and the like are stored. The vehicle state b7 is information based on a result of the infrastructure server 20 analyzing an image from the infrastructure camera 21 and is updated at any time.

The vehicle position b8 indicates the position of the vehicle 70 on the inside of the parking lot 13. In the vehicle position b8, a coordinate value that can specify a position on the inside of the parking lot 13 is stored. The vehicle position b8 is information based on a result of the infrastructure server 20 analyzing the image from the infrastructure camera 21 and is updated at any time.

The camera ID b9 is information that specifies the infrastructure camera 21 currently imaging the vehicle 70.

The entrance b10 is information that specifies an entrance gate through which the vehicle 70 passed when entering the parking lot 13. The entrance b10 is specified by an installation position of the entrance camera 22 that captured an image in which the vehicle 70 is reflected.

The parking position b11 is, for example, a parking frame number indicating the position of a parking frame in which the vehicle 70 is parked. Note that, when the vehicle state b7 is “parked”, the coordinate value indicated by the vehicle position b8 and the parking frame number indicated by the parking position b11 indicate the same position.

The exit b12 is information for determining an exit gate through which the vehicle 70 passed when exiting the parking lot 13. The exit b12 is determined by an installation position of the exit camera 23 that captured an image in which the vehicle 70 is included. Note that the information about the exit b12 is not used in the present embodiment.

The parking start time b13 is time at which the vehicle 70 enters the parking lot 13. Specifically, the parking start time b13 is time at which the entrance camera 22 images the license plate of the vehicle 70. Note that the parking start time b13 may be time at which the infrastructure server 20 (the recognition server 20b) determines that the vehicle 70 completes parking, on the basis of an image acquired by the infrastructure camera 21.

The parking end time b14 is time at which the vehicle 70 exits the parking lot 13. Specifically, the parking end time b14 is time at which the exit camera 23 images the license plate of the vehicle 70. Note that the parking end time b14 may be time at which the infrastructure server 20 (the recognition server 20b) determines that the vehicle 70 starts moving from the parking position, on the basis of the image acquired from the infrastructure camera 21.

The parking position distance b15 is a distance from the parking position of the vehicle 70 to the closest entrance connecting the parking lot 13 and the commercial facility 15, calculated by the infrastructure server 20 (the recognition server 20b).

### (Configuration of Map Data)

A configuration of the map data 100c stored by the infrastructure server 20 (the navigation server 20a) will be described with reference to FIG. 10. FIG. 10 is a diagram illustrating an example of a configuration of the map data stored by the infrastructure server according to the embodiment.

The map data 100c includes a commercial facility name c1, parking lot map data c2, commercial facility map data c3, and camera position data c4.

The commercial facility name c1 is data indicating a name of the commercial facility 15. The commercial facility name c1 may include not only the name of the commercial facility 15 but also names of tenants in the commercial facility 15.

The parking lot map data c2 is map data indicating the positions of parking frames of the parking lot 13 and parking frame numbers allocated to the parking frames.

The commercial facility map data c3 is map data indicating arrangement of stores, the position of entrances and exits, and the like of the commercial facility 15.

The camera position data c4 is map data indicating positions where the infrastructure camera 21, the entrance camera 22, and the exit camera 23 are disposed.

Note that these pieces of data included in the map data 100c do not need to be actual map data and may be index information indicating a storage destination of the actual map data.

### (Configuration of User Data)

A configuration of the user data 100e stored by the store server 30 (the point server 30b) will be described with reference to FIG. 11. FIG. 11 is a diagram illustrating an example of a configuration of the user data stored by the store server according to the embodiment.

The user data 100e includes a facility e1, a point ID e2, a name e3, an address e4, a telephone number e5, a mail address e6, an age e7, a sex e8, a number of remaining points e9, a family point ID e10, and a use store/frequency e11.

The facility e1 is identification information that uniquely identifies the commercial facility 15.

The point ID e2 is identification information that is managed by the store server 30 and uniquely identifies the user.

The name e3 is a name of the user who corresponds to the point ID e2.

The address e4 is an address of the user who corresponds to the point ID e2.

The telephone number e5 is a telephone number of the user who corresponds to the point ID e2.

The mail address e6 is a mail address of the operation terminal 60 carried by the user who corresponds to the point ID e2.

The age e7 is an age of the user who corresponds to the point ID e2.

The sex e8 is sex of the user who corresponds to the point ID e2.

The number of remaining points e9 is a current number of points granted to the user who corresponds to the point ID e2.

The family point ID e10 is a point ID correlated with the user who corresponds to the point ID e2.

The use store/frequency e11 is identification information for uniquely identifying a store used in the facility e1 by the user who corresponds to the point ID e2 and information indicating frequency of use about the store. Note that, in the use store/frequency e11, store information and frequency information about the store may be separately defined.

### (Configuration of Point Data)

A configuration of the point data 100f stored by the store server 30 (the point server 30b) will be described with reference to FIG. 12. FIG. 12 is a diagram illustrating an example of a configuration of the point data stored by the store server according to the embodiment;

The point data 100f includes a point ID f1, a purchase store f2, a purchase date and time f3, a purchase item f4, a price f5, a number of items f6, a discount rate f7, and a number of points f8.

The point ID f1 is identification information that is managed by the store server 30 and uniquely identifies the user.

The purchase store f2 is identification information that uniquely identifies a store where the user purchased an item in the commercial facility 15.

The purchase date and time f3 is information indicating a date and time at which the user purchases the purchase item f4.

The purchase item f4 is, for example, information indicating an item code that uniquely identifies the item purchased in the purchase store f2.

The price f5 is information indicating a price of the purchase item f4.

The number of items f6 is information indicating the number of purchase items f4.

The discount rate f7 is information indicating a discount rate of the price f5 of the purchase item f4 from a regular price.

The number of points f8 is information indicating the number of points granted to the user who corresponds to the point IDf1 by purchasing the purchase item f4.

### (Configuration of POS Data)

A configuration of the POS data 100g stored by the store server 30 (the POS server 30c) will be described with reference to FIG. 13. FIG. 13 is a diagram illustrating an example of a configuration of the POS data stored by the store server according to the embodiment.

The POS data 100g includes a store g1, recommendation information/coupon information g2, a point ID g3, a purchase date and time g4, a purchase item g5, a price g6, a number of items g7, and a discount rate g8.

The store g1 is identification information that uniquely identifies a store in the commercial facility 15.

The recommendation information/coupon information g2 is recommendation information and coupon information relating to the store g1.

The point ID g3 is identification information that is managed by the store server 30 and uniquely identifies the user.

The purchase date and time g4 is information indicating a date and time at which the user purchases the purchase item g5.

The purchase item g5 is, for example, information indicating an item code that uniquely identifies an item purchased in the store g1.

The price g6 is information indicating a price of the purchase item g5.

The number of items g7 is information indicating the number of purchase items g5.

The discount rate g8 is information indicating a discount rate of the price g6 of the purchase item g5 from a regular price.

### (Configuration of Similar Store Data)

A configuration of the similar store data 100h stored by the store server 30 (the similar store server 30a) will be described with reference to FIG. 14. FIG. 14 is a diagram illustrating an example of a configuration of the similar store data stored by the store server according to the embodiment.

The similar store data 100h includes a facility h1, a store h2, and a similar store h3.

The facility h1 is identification information that uniquely identifies the commercial facility 15.

The store h2 is identification information that uniquely identifies a store in the commercial facility 15.

The similar store h3 is identification information that uniquely identifies a store in the commercial facility 15 that sells an item similar to an item sold by the store h2, namely, sells an item belonging to the same category as a category to which the item sold in the store h2 belongs. Note that the item category is information indicating male clothes, female clothes, child clothes, or household products.

### (Procedure of Processing Performed by Parking Information-Linked Recommendation System)

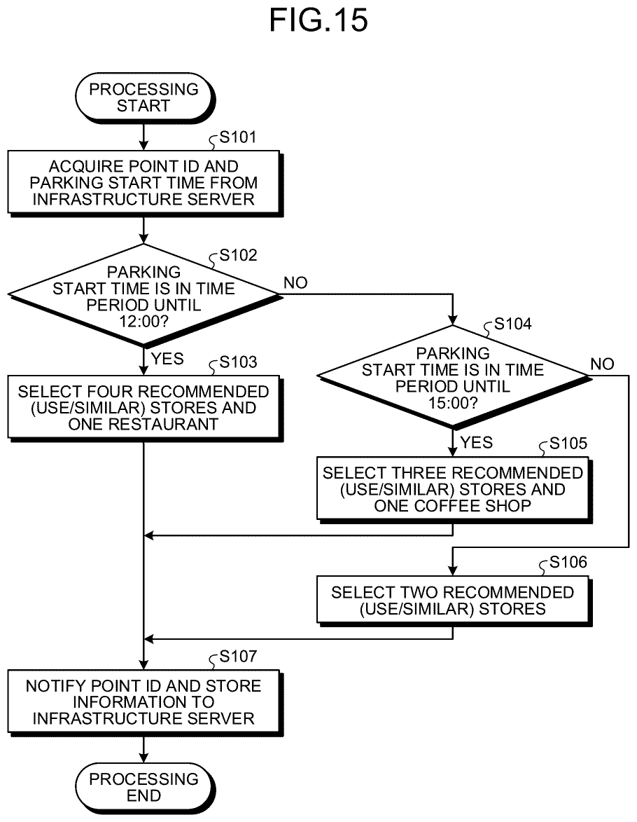

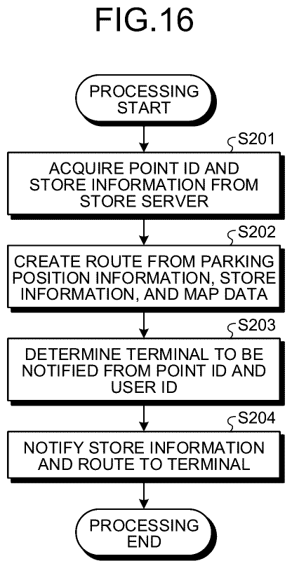

A procedure of processing executed by the parking information-linked recommendation system 10 will be described with reference to FIG. 15 and FIG. 16.

FIG. 15 is a flowchart illustrating an example of a procedure of processing executed by the store server 30 in the parking information-linked recommendation system 10 according to the embodiment.

The acquisition unit 52 of the store server 30 (the WEB server 30d) acquires the point ID and the parking start time of the user correlated with the vehicle 70 from the infrastructure server 20 (the WEB server 20d) (step S101).

Note that, prior to the processing at step S101, the acquisition unit 52 of the infrastructure server 20 (the recognition server 20b) acquires, out of images captured by the infrastructure cameras 21, an image including the vehicle 70 that passed through the entrance gate (since the image is an image during parking, the image is hereinafter referred to as parking image) and the camera ID of the infrastructure camera 21 that captured the image. The data processing unit 54 of the infrastructure server 20 (the recognition server 20b) calculates a parking position from the camera ID and the parking image and the parking lot map data c2 stored in the navigation server 20a. The data processing unit 54 of the infrastructure server 20 (the recognition server 20b) specifies the parking start time from the camera ID and the parking image.

The data processing unit 54 of the store server 30 (the similar store server 30a) determines whether the parking start time acquired at step S101 is in a time period of a lunch time that is until 12:00 (step S102). In response to determining that the parking start time is in the time period of the lunch time (step S102: Yes), the processing proceeds to step S103. On the other hand, in response to determining that the parking start time is after the lunch time (step S102: No), the processing proceeds to step S104.

The data processing unit 54 of the store server 30 (the similar store server 30a) selects four recommended (use/similar) stores and one restaurant (step S103). Thereafter, the processing proceeds to step S107.

The data processing unit 54 of the store server 30 (the similar store server 30a) determines whether the parking start time acquired at step S101 is in a time period that is until 15:00 (step S104). In response to determining that the parking start time is in the time period until 15:00 (step S104: Yes), the processing proceeds to step S105. On the other hand, in response to determining that the parking start time is not in the time period until 15:00 (step S104: No), the processing proceeds to step S106.

The data processing unit 54 of the store server 30 (the similar store server 30a) selects three recommended (use/similar) stores and one coffee shop (step S105). Thereafter, the processing proceeds to step S107.

The data processing unit 54 of the store server 30 (the similar store server 30a) selects two recommended (use/similar) stores (step S106). Thereafter, the processing proceeds to step S107.

The output unit 56 of the store server 30 (the WEB server 30d) notifies the infrastructure server 20 about the recommendation information representing the store selected at step S103, step S105, or step S106 and the point ID (step S107). Thereafter, the store server 30 ends the processing illustrated in FIG. 15.

FIG. 16 is a flowchart illustrating an example of a procedure of processing executed by the infrastructure server 20 in the parking information-linked recommendation system 10 according to the embodiment. The processing illustrated in FIG. 16 is executed after the processing illustrated in FIG. 15.

The acquisition unit 52 of the infrastructure server 20 (the WEB server 20d) acquires the point ID and the recommendation information representing the store information about the recommended store from the store server 30 (step S201).

The data processing unit 54 of the infrastructure server 20 (the navigation server 20a) creates map information representing a route from the parking position of the vehicle 70 to the recommended store via the closest entrance connecting the parking lot 13 and the commercial facility 15 (step S202). The map information is created on the basis of the information about the position of the recommended store included in the recommendation information, the parking position information indicating the parking position of the vehicle 70, and the positions of the entrances and the exits of the commercial facility map data cd stored in the navigation server 20a.

The data processing unit 54 of the infrastructure server 20 (the account server 20c) determines, on the basis of the point ID or the user ID correlated with the point ID, the operation terminal 60 to be notified about the recommendation information and the map information (step S203).

The output unit 56 of the infrastructure server 20 (the WEB server 20d) notifies the operation terminal 60 determined at step S203 about the recommendation information and the map information (step S204). Thereafter, the infrastructure server 20 ends the processing illustrated in FIG. 16.

### (Example of a Registration Screen for User Information)

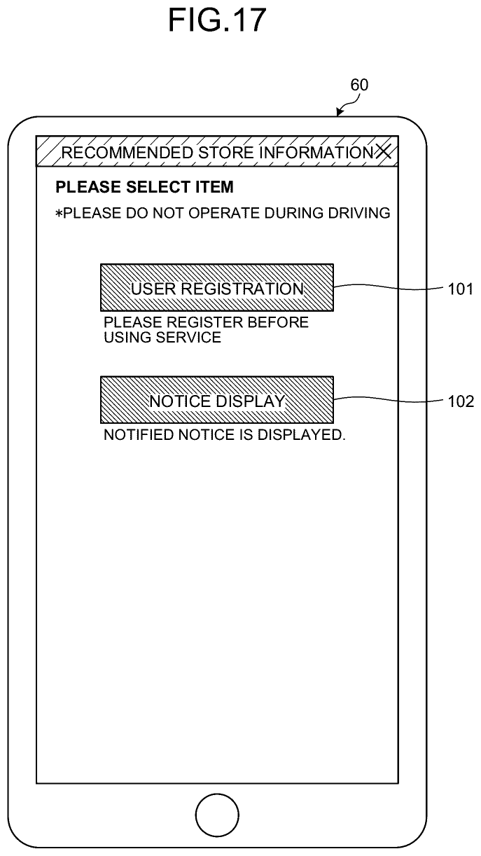

An example of a registration screen at the time at which the user who uses the parking information-linked recommendation system 10 registers user data by using the operation terminal 60 will be described with reference to FIG. 17 to FIG. 20. FIG. 17 is a diagram illustrating an example of a main menu screen displayed on the operation terminal.

FIG. 17 is an example of a main menu screen of an application of the parking information-linked recommendation system 10 displayed on the operation terminal 60 of the user. On the main menu screen, operation buttons indicating entrances to menus of a user registration button 101 and a notice display button 102 are displayed.

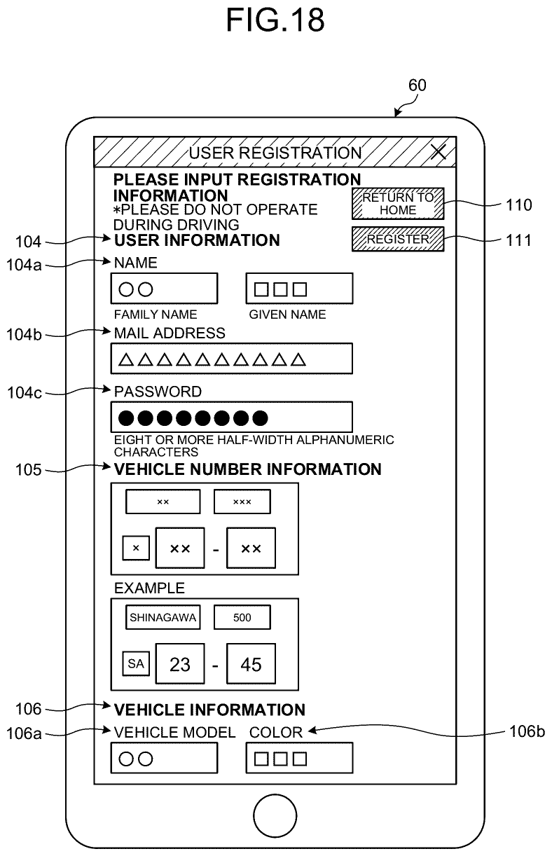

The user registration button 101 is a button that the user presses when registering user information and vehicle information such as a vehicle number. When the user registration button 101 is pressed, the main menu screen transitions to a user registration screen illustrated in FIG. 18.

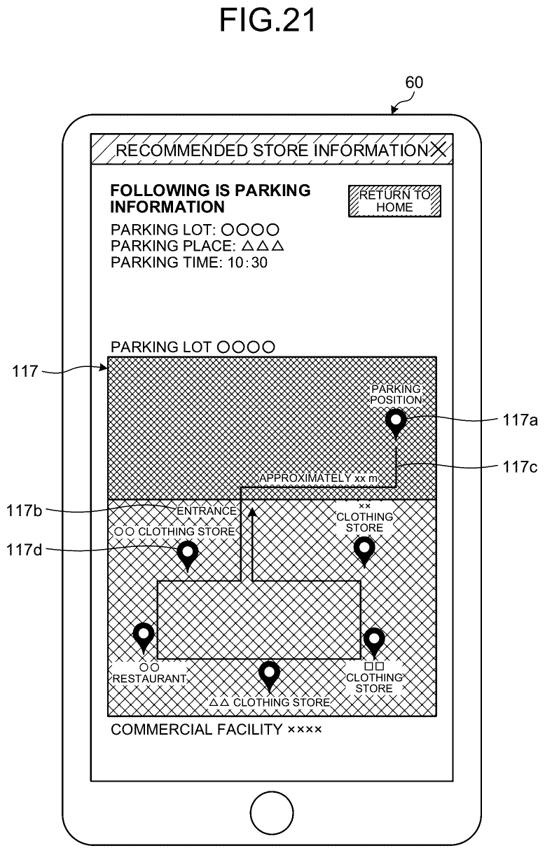

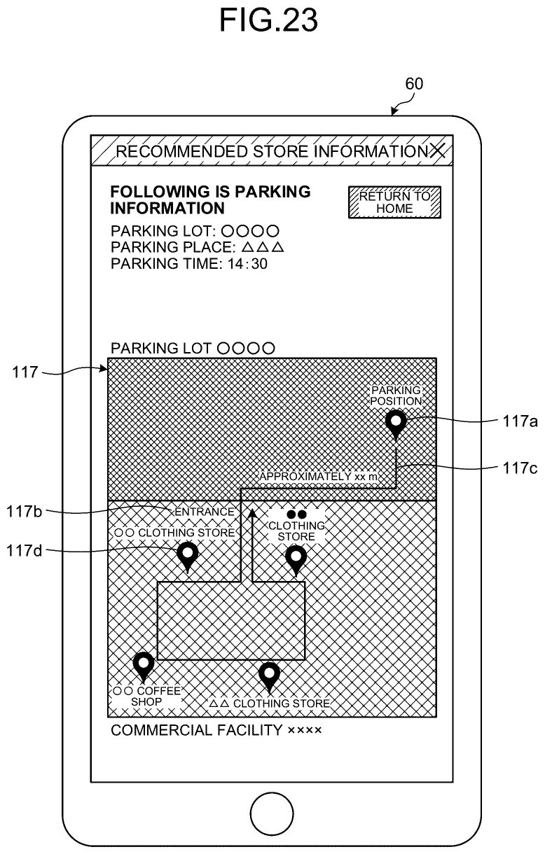

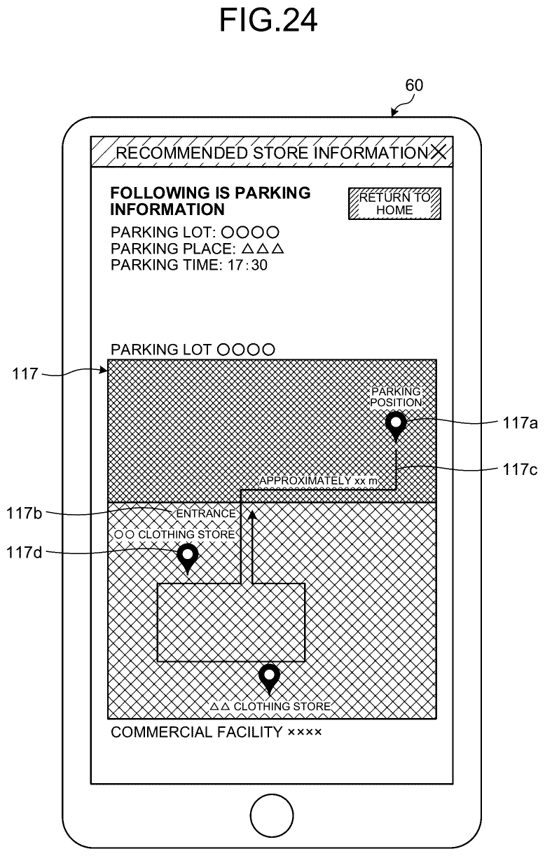

The notice display button 102 is a button that the user presses for viewing the recommendation information delivered to the operation terminal 60 of the user. When the notice display button 102 is pressed, the main menu screen transitions to a display screen for recommendation information illustrated in FIG. 21, FIG. 23, or FIG. 24.

FIG. 18 is a diagram illustrating an example of a user registration screen displayed on the operation terminal. The user registration screen is displayed when the user registration button 101 is pressed on the main menu screen. On the user registration screen, a return to home button 110, a registration button 111, a user information input field 104, a vehicle number information input field 105, and a vehicle information input field 106 are displayed. Note that FIG. 18 illustrates a state in which information is input to the input fields, but, when the main menu screen transitions to the user registration screen, all the input fields are blank.

The return to home button 110 is, for example, a button that the user presses when desiring to transition the user registration screen to the main menu screen illustrated in FIG. 17.

The registration button 111 is a button that user presses when registering content input on the user registration screen.

The user information input field 104 includes a name input field 104a, a mail address input field 104b, and a password input field 104c.

The name input field 104a is a field for inputting a full name of the user.

The mail address input field 104b is a field for inputting a mail address of the user.

The password input field 104c is a field for inputting a password of the user.

The vehicle number information input field 105 is a field for inputting content of the license plate of the vehicle 70 used by the user.

The vehicle information input field 106 includes a vehicle model input field 106a and a color input field 106b.

The vehicle model input field 106a is a field for inputting a vehicle model name of the vehicle 70.

The color input field 106b is a field for inputting a color of the vehicle 70.

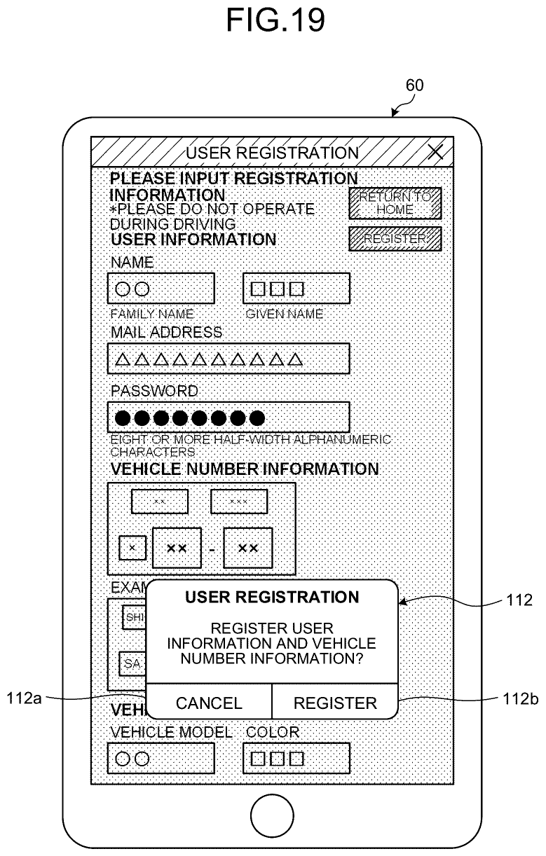

FIG. 19 is a diagram illustrating an example of a screen displayed when input user information is registered in the infrastructure server. FIG. 19 is an example of a screen to be displayed when the registration button 111 illustrated in FIG. 18 is pressed after necessary information is input on the user registration screen illustrated in FIG. 18.

When the registration button 111 illustrated in FIG. 18 is pressed, a user registration execution confirmation window 112 is displayed on the operation terminal 60 in a state of being superimposed on the hatched user registration screen as illustrated in FIG. 19. The user registration execution confirmation window 112 includes a cancel button 112a and a registration button 112b.

The cancel button 112a is a button for canceling execution of user registration. When the cancel button 112a is pressed, the screen transitions to the user registration screen illustrated in FIG. 18.

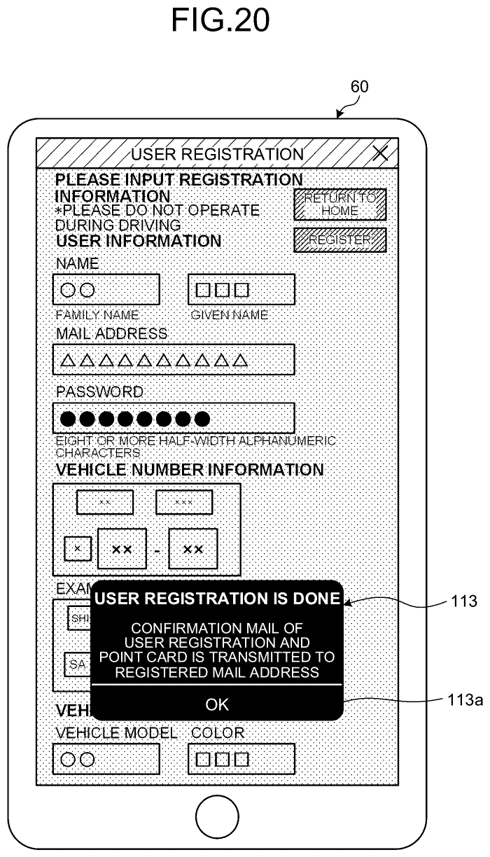

The registration button 112b is a button for instructing execution of user registration. When the registration button 112b is pressed, the information input on the user registration screen is registered in the infrastructure server 20 (the account server 20c). Then, a screen of the operation terminal 60 transitions to a screen illustrated in FIG. 20 described below.

FIG. 20 is a diagram illustrating an example of a feedback screen indicating that the user information has been registered. On the feedback screen, a registration confirmation window 113 is displayed in a state of being superimposed on the hatched user registration screen. The registration confirmation window 113 is a message window for notifying that the user information and the information about the point card are transmitted to registered mail address. The registration confirmation window 113 includes a confirmation button 113a.

The confirmation button 113a is a button for permitting transmitting the user information and the information about the point card to the operation terminal 60. When the user of the operation terminal 60 presses the confirmation button 113a, the infrastructure server 20 transmits an electronic mail including the registered user information and the information about the point card to the registered mail address, namely, to the operation terminal 60 on which the registration operation has been performed. The user confirms the user information and the information about the point card described in the received electronic mail and thereby recognizes that the registration of the user information has been completed.

### (Example of a Display Screen for Recommendation Information)

An example of a screen displayed when the parking information-linked recommendation system 10 notifies the operation terminal 60 about the user recommendation information will be described with reference to FIG. 21 to FIG. 24. Notification screens illustrated in FIG. 21 to FIG. 24 are respectively displayed when the notice display button 102 illustrated in FIG. 17 is pressed. Note that the notification screens illustrated in FIG. 21 to FIG. 24 may be respectively displayed when the confirmation button 113a illustrated in FIG. 20 is pressed.

FIG. 21 is a diagram illustrating an example of a notification screen for recommendation information displayed on the operation terminal. The notification screen illustrated in FIG. 21 displays the recommendation information representing the recommended store in the case where the parking time is included in the meal time period (step S103 in FIG. 15).

The notification screen for the recommendation information includes a map 117. The map 117 includes a walking route 117c and a recommended store icon 117d. The walking route 117c indicates a route from a parking position 117a in the parking lot 13 to the recommended store via an entrance 117b connecting the parking lot 13 and the commercial facility 15. The recommended store icon 117d indicates the recommended store.

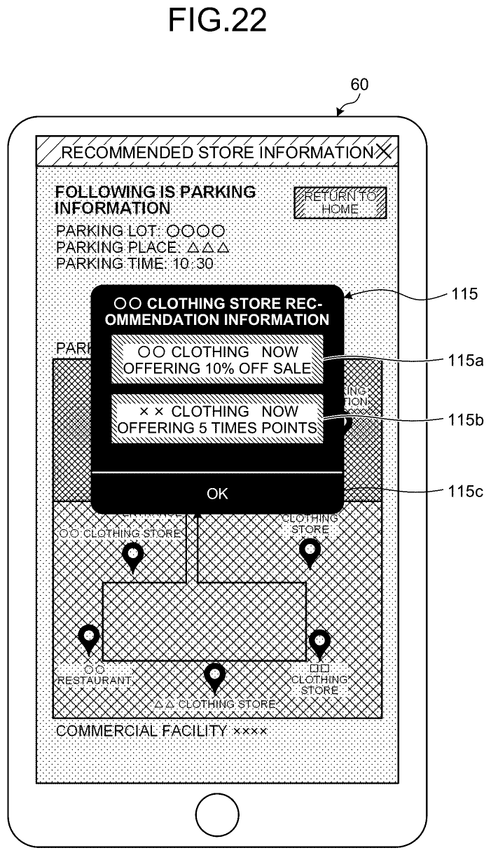

The recommended store icon 117d is information representing the position of the recommended store on the map 117. The recommended store icon 117d serves as a button for instructing display of detailed information about the recommended store. When the recommended store icon 117d is pressed, the notification screen transitions to a recommended store information detailed display screen illustrated in FIG. 22.

FIG. 22 is a diagram illustrating an example of a detailed display screen for recommendation information indicating recommended stores, which is displayed on the operation terminal. The detailed display screen for the recommendation information illustrated in FIG. 22 is displayed when the recommended store icon 117d illustrated in FIG. 21 is pressed.

The recommended store icon 117d includes a detailed display window 115 for the recommendation information superimposed on the screen of the operation terminal 60. The detailed display window 115 for the recommendation information includes, for example, sale information 115a, point information 115b, and a confirmation button 115c.

The sale information 115a is information representing contents of sales carried out in one recommended store displayed at the top of the detailed display window 115 for the recommendation information.

The point information 115b is information representing incentive provision carried out in one store displayed at the top of the detailed display window 115 for the recommendation information.

Note that the detailed display window 115 for the recommendation information is not limited to include the sale information 115a and the point information 115b and may include information about a coupon usable in the store.

The confirmation button 115c is a button for ending the detailed display of the recommendation information. When the confirmation button 115c is pressed, the detailed display screen transitions to the screen illustrated in FIG. 21.

FIG. 23 is a diagram illustrating an example of a notification screen for recommendation information displayed on the operation terminal. The notification screen illustrated in FIG. 21 displays recommendation information representing a recommended store in the case where the parking time is in the time period after the lunch time and is not included in the meal time period (step S105 in FIG. 15). The notification screen is the same as the notification screen illustrated in FIG. 21 except that recommended stores are changed with the parking time.

FIG. 24 is a diagram illustrating an example of a notification screen for recommendation information displayed on the operation terminal. The notification screen illustrated in FIG. 21 displays recommendation information representing recommended stores in the case where the parking time is the time period after the lunch time and is not included in the meal time period (step S106 in FIG. 15). The notification screen is the same as the notification screen illustrated in FIG. 21 except that recommended stores are changed with the parking time.

### (Action and Effect of the Present Embodiment)

As described above, in the parking information-linked recommendation system 10 according to the present embodiment, an information provision method is implemented by the sales information management system 14. The sales information management system 14 includes the store server 30 (the second server) that communicates with the parking lot management system 12. The parking lot management system 12 includes the infrastructure server 20 (the first server) relating to the parking lot 13. The store server 30 relates to the commercial facility 15 and stores the purchase information about the user in the commercial facility 15 to correlate with the point ID of the user.

In a case where the commercial facility 15 is provided with the parking lot 13, convenience of the user is improved if the user can obtain information on the commercial facility 15 at the timing when the user parks the vehicle 70 in the parking lot 13. On the other hand, such studies have not sufficiently progressed so far, and there is room for improvement.

Under such circumstances, in the information provision method in the sales information management system 14, a point ID and parking time information is acquired from the infrastructure server 20. The point ID corresponds to the user riding on the vehicle 70 parked in the parking lot 13. The parking time information indicates parking time at which the user parked the vehicle 70 in a predetermined parking position in the parking lot 13. Here, the vehicle number indicating the vehicle 70 and the parking time information are determined by the parking lot management system 12 by using a vehicle image showing the vehicle 70 acquired by a camera installed in the parking lot 13. The point ID corresponding to the user is determined by the parking lot management system 12 on the basis of the vehicle number. In the information provision method in the sales information management system 14, when the parking time is included in a meal time period on the basis of purchase information and the parking time information about the user who corresponds to the point ID, recommendation information is transmitted to the infrastructure server 20 to cause the operation terminal 60 (the information terminal) of the user who corresponds to the point ID to display the recommendation information. The recommendation information includes first position information and second position information. The first position information represents at least one of stores each of whose frequency of use by the user is equal to or higher than a given level. The second position information represents at least one restaurant.

With the configuration above, when the parking time is included in the meal time period, it is possible to provide the recommendation information including not only the first position information about one of stores each of whose frequency of use by the user is equal to or higher than the given level but also the second position information about one restaurant to the user. Therefore, according to the parking information-linked recommendation system 10 of the present embodiment, it is possible to efficiently support a use plan of the commercial facility 15 by the user at the timing when the user parks the vehicle 70 in the parking lot 13, namely, at the timing when the user is about to start the use of the commercial facility 15, and thus improve convenience of the user.

In the information provision method in the parking information-linked recommendation system 10 according to the present embodiment, the parking lot management system 12 stores the point ID of the user to correlate with the vehicle number of the user. With this configuration, upon detecting that the user enters the parking lot 13, it is possible to recognize that the user visits the commercial facility 15.

In the information provision method in the parking information-linked recommendation system 10 according to the present embodiment, the recommendation information and/or the map information is transmitted from the infrastructure server 20 (the first server) to the operation terminal 60 of the user. Therefore, since the store server 30 does not need to have a communication function with the operation terminal 60, a system configuration can be simplified.

In the information provision method in the parking information-linked recommendation system 10 according to the present embodiment, when transmitting the recommendation information to the operation terminal 60 of the user, the infrastructure server 20 (the first server) transmits, together with the recommendation information, map information representing a route from a parking position of the vehicle 70 to a recommended store of the recommendation information via an entrance connecting the parking lot 13 and the commercial facility 15. With this configuration, the recommendation information and the map information can be transmitted together from the infrastructure server 20 to the operation terminal 60 of the user. Thus, the user can easily grasp the recommendation information on a map.

In the information provision method in the parking information-linked recommendation system 10 according to the present embodiment, when the parking time is outside the meal time period, the map information indicates the first position of at least one store without indicating the second position of at least one restaurant. With this configuration, the recommended store can be changed with the parking time. Additionally, the user can easily grasp, at timing when the user is about to start using the commercial facility 15, a use plan of the commercial facility 15 that is appropriate at that point in time.

In the information provision method in the parking information-linked recommendation system 10 according to the present embodiment, the meal time period includes a lunch time. Alternatively, in the information provision method in the parking information-linked recommendation system 10 according to the present embodiment, the meal time period includes a lunch time and a time period a predetermined time before the lunch time. With this configuration, the user can receive presentation of recommendation information representing a recommended store including a restaurant at the lunch time without being aware of the presentation.

In the information provision method in the parking information-linked recommendation system 10 according to the present embodiment, when the parking time is after the lunch time, the map information indicates the first position of at least one store without indicating the second position of at least one restaurant. Alternatively, in the information provision method in the parking information-linked recommendation system 10 according to the present embodiment, when the parking time is after the lunch time, the map information indicates a third position of at least one coffee shop together with the first position of at least one store, without indicating the second position of at least one restaurant. With this configuration, the recommended store can be changed with the parking time. Thus, the user can easily grasp, at timing when the user is about to start using the commercial facility 15, a use plan of the commercial facility 15 that is appropriate at that point in time.

In the information provision method in the parking information-linked recommendation system 10 according to the present embodiment, the user includes a driver of the vehicle 70. With this configuration, the user correlated with the vehicle 70 can be identified by identifying the vehicle 70 that has entered the parking lot 13.

In the information provision method in the parking information-linked recommendation system 10 according to the present embodiment, the user includes a fellow passenger of the vehicle 70 managed as a family member of the driver of the vehicle 70. With this configuration, a family member, a friend, or the like correlated with the user of the vehicle 70 in advance can be identified by identifying the vehicle 70 that has entered the parking lot 13.

In an information provision method in the sales information management system 14, a point ID and parking time information is acquired from the infrastructure server 20. The point ID corresponds to the user riding on the vehicle 70 parked in the parking lot 13. The parking time information indicates parking time at which the user parked the vehicle 70 in a predetermined parking position in the parking lot 13. Here, the vehicle number indicating the vehicle 70 and the parking time information are determined by the parking lot management system 12 by using a vehicle image showing the vehicle 70 acquired by a camera installed in the parking lot 13. The point ID corresponding to the user is determined by the parking lot management system 12 on the basis of the vehicle number. In the information provision method in the sales information management system 14, when the parking time is after a time of a lunch time on the basis of purchase information and the parking time information about the user who corresponds to the point ID, recommendation information is transmitted to the infrastructure server 20 to cause the operation terminal 60 (the information terminal) of the user who corresponds to the point ID to display the recommendation information. The recommendation information includes first position information and third position information. The first position information represents at least one of stores each of whose frequency of use by the user is equal to or higher than a given level. The third position information represents at least one coffee shop.

With the configuration above, when the parking time is after the time of the lunch time, it is possible to provide, to the user, the recommendation information including not only the first position information about one of stores each of whose frequency of use by the user is equal to or higher than the given level but also the third position information about one coffee shop. Therefore, according to the parking information-linked recommendation system 10 according to the present embodiment, it is possible to efficiently support a use plan of the commercial facility 15 by the user at the timing when the user parks the vehicle 70 in the parking lot 13, namely, at the timing when the user is about to start the use of the commercial facility 15, and thus improve convenience of the user.

While some embodiments have been described, these embodiments have been presented by way of example only, and are not intended to limit the scope of the inventions. Indeed, the novel methods and systems described herein may be embodied in a variety of other forms; moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information provision method implemented by an information management system, the information management system performing communication with a parking lot management system including a first server relating to a parking lot, the information management system including a second server relating to a commercial facility, the second server storing purchase information about purchase by a user in the commercial facility to correlate with a point ID of the user, the information provision method comprising:
acquiring a point ID and parking time information from the first server, the point ID corresponding to the user riding on a vehicle parked in the parking lot, the parking time information indicating parking time at which the user parks the vehicle in a predetermined parking position in the parking lot, a vehicle number indicating the vehicle and the parking time information being determined by the parking lot management system by using a vehicle image showing the vehicle acquired by a camera installed in the parking lot, the corresponding point ID being determined by the parking lot management system on the basis of the vehicle number; and,
when the parking time is included in a meal time period on the basis of the purchase information and the parking time information about the user who corresponds to the point ID, transmitting recommendation information to the first server to cause an information terminal of the user who corresponds to the point ID to display the recommendation information, the recommendation information including first position information and second position information, the first position information representing at least one of stores each of whose frequency of use by the user is equal to or higher than a given level, the second position information representing at least one restaurant.

2. The information provision method according to claim 1, wherein the point ID is stored to correlate with the vehicle number in the parking lot management system.

3. The information provision method according to claim 1, wherein the recommendation information is transmitted from the first server to the information terminal.

4. The information provision method according to claim 3, wherein the transmitting of the recommendation information includes transmitting, from the first server to the information terminal, map information representing a route from the parking position to the at least one of stores via an entrance connecting the commercial facility and the parking lot.

5. The information provision method according to claim 4, wherein, when the parking time is outside the meal time period, the map information indicates the first position of the at least one of stores without indicating the second position of the at least one restaurant.

6. The information provision method according to claim 1, wherein the meal time period includes a lunch time.

7. The information provision method according to claim 1, wherein the meal time period includes a lunch time and a time period a predetermined time before the lunch time.

8. The information provision method according to claim 4, wherein, when the parking time is after a lunch time, the map information indicates the first position of the at least one of stores without indicating the second position of the at least one restaurant.

9. The information provision method according to claim 4, wherein, when the parking time is after a lunch time, the map information indicates a third position of at least one coffee shop together with the first position of the at least one of stores without indicating the second position of the at least one restaurant.

10. The information provision method according to claim 1, wherein the user includes a driver of the vehicle.

11. The information provision method according to claim 1, wherein the user includes an occupant of the vehicle managed as a family member of a driver of the vehicle.

12. An information provision method implemented by an information management system, the information management system performing communication with a parking lot management system including a first server relating to a parking lot, the information management system including a second server relating to a commercial facility, the second server storing purchase information about purchase by a user in the commercial facility to correlate with a point ID of the user, the information provision method comprising:
acquiring a point ID and parking time information from the first server, the point ID corresponding to the user riding on a vehicle parked in the parking lot, the parking time information indicating parking time at which the user parks the vehicle in a predetermined parking position in the parking lot, a vehicle number indicating the vehicle and the parking time information being determined by the parking lot management system by using a vehicle image showing the vehicle acquired by a camera installed in the parking lot, the corresponding point ID being determined by the parking lot management system on the basis of the vehicle number; and,
when the parking time is after a time of a lunch time on the basis of the purchase information and the parking time information about the user who corresponds to the point ID, transmitting recommendation information to the first server to cause an information terminal of the user who corresponds to the point ID to display the recommendation information, the recommendation information including first position information and third position information, the first position information representing at least one of stores each of whose frequency of use by the user is equal to or higher than a given level, the third position information representing at least one coffee shop.

13. An information management system performing communication with a parking lot management system including a first server relating to a parking lot, the information management system comprising
a second server relating to a commercial facility, the second server including
a memory in which purchase information about purchase by a user in the commercial facility is stored to correlate with a point ID of the user, and
a hardware processor connected to the memory to execute processing, the processing including:
acquiring a point ID and parking time information from the first server, the point ID corresponding to the user riding on a vehicle parked in the parking lot, the parking time information indicating parking time at which the user parks the vehicle in a predetermined parking position in the parking lot, a vehicle number indicating the vehicle and the parking time information being determined by the parking lot management system by using a vehicle image showing the vehicle acquired by a camera installed in the parking lot, the corresponding point ID being determined by the parking lot management system on the basis of the vehicle number; and,
when the parking time is included in a meal time period on the basis of the purchase information and the parking time information about the user who corresponds to the point ID, transmitting recommendation information to the first server to cause an information terminal of the user who corresponds to the point ID to display the recommendation information, the recommendation information including first position information and second position information, the first position information representing at least one of stores each of whose frequency of use by the user is equal to or higher than a given level, the second position information representing at least one restaurant.
